(19) United States
(12) Patent Application Publication
(10) Pub. No.: US 2023/0053620 A1
(43) Pub. Date: Feb. 23, 2023

(54) PARTICLE SIZE CONTROL METHOD

(71) Applicant: COATEX, Genay (FR)

(72) Inventors: Benoit MAGNY, Fontaines Saint Martin (FR); Celine METHIVIER, Genas (FR); Jacques MONGOIN, Quincieux (FR)

(73) Assignee: COATEX, Genay (FR)

(21) Appl. No.: 17/759,255

(22) PCT Filed: Feb. 3, 2021
(86) PCT No.: PCT/FR2021/000008

§ 371 Date: Jul. 21, 2022

(30) Foreign Application Priority Data
Feb. 6, 2020 (FR) 2001181

(51) Int. Cl. C09C 3/04; C01B 25/01; C09K 23/52; C08F 20/06

(52) U.S. Cl. CPC C09C 3/041; C01B 25/01; C09K 23/52; C08F 20/06; C01P 2004/61

(57) ABSTRACT

The invention relates to a method for grinding phosphate rock in the presence of a particular anionic polymer having a molecular weight of between 1000 and 90000 g/mol, which makes it possible to control the extent (S) of the volume distribution of the particle size of obtained phosphate mineral particles. The invention also relates to a method for improving the production yield of a phosphate rock grinding method.

The invention relates to a method for grinding phosphate rock in the presence of a particular anionic polymer having a molecular weight comprised between 1,000 and 90,000 g/mol and which makes it possible to control the extent (S) of the volume distribution of the particle size of obtained phosphate mineral particles. The invention also provides a method for improving the production yield of a phosphate rock grinding method.

Phosphate or phosphate rock makes it possible in particular to prepare phosphoric acid. After mining, the phosphate rock is crushed, then ground and treated in an acid medium in order to produce phosphoric acid.

Grinding phosphate rock generally leads to particles with very large variations in size distribution.

The ground phosphate rock particles generally conveyed or used in phosphoric acid preparation plants must generally be less than 500 μm in size (d_{0.5}), preferably less than 300 μm or less than 200 μm. These particles must generally be greater than 10 μm in size (d_{0.5}), preferably greater than 40 μm or greater than 50 μm.

In fact, the acid treatment requires controlling this particle size distribution. Indeed, oversized particles must generally be ground again, whereas undersized particles must be separated. Undersized particles are then lost.

Thus, repeatedly grinding oversized particles or removing undersized particles results in a decrease in the production yield.

It also has negative consequences from an environmental perspective.

It is therefore important to be able to have phosphate rock grinding methods that make it possible to control the size of the ground particles. It is also important to have phosphate rock grinding methods that make it possible to prepare aqueous suspensions of phosphate mineral particles in which the extent of the volume distribution of particle sizes [(d_{0.9}−d_{0.1})/d_{0.5}] measured by laser diffraction is controlled.

According to the invention, the extent of the particle size distribution is evaluated based on three characteristics of the ground particle sizes (d_{0.9}, d_{0.1}, d_{0.5}) obtained using the grinding method according to the invention.

According to the invention, characteristic d_{0.5} or median diameter is the particle diameter value of a particle population for which 50% by volume of the particles have a size smaller than this value. In this case, 50% by volume of the particles have a size greater than this value. For a volume distribution, 50% of the total volume of the particle population corresponds to the volume of particles with diameters smaller than d_{0.5}. Graphically, the median size is therefore the diameter that divides the distribution into two equal areas.

According to the invention, characteristic d_{0.9} is the particle diameter value of a particle population for which 90% by volume of particles have a size smaller than this value. In this case, 10% by volume of the particles have a size greater than this value.

According to the invention, characteristic d_{0.1} is the particle diameter value of a particle population for which 90% by volume of the particles have a size greater than this value.

According to the invention, the volume size of the particles is measured by laser diffraction and the extent of the volume distribution of particle sizes is calculated according to the formula [(d_{0.9}−d_{0.1})/d_{0.5}]. This extent of the particle size distribution is also referred to as span.

There are known phosphate rock grinding methods. However, these phosphate rock grinding methods are unsatisfactory. There is therefore a need for improved phosphate rock grinding methods.

Document WO 2019092381 describes a method for preparing an aqueous suspension of phosphate rock that is carried out without grinding. Document U.S. Pat. No. 5,183,211 describes a method for reducing the viscosity of a phosphate rock slurry when grinding the ore. Document EP1160197 also describes a phosphate rock grinding method that uses a cross-linked polymer.

The method according to the invention provides a solution to all or part of the problems of the phosphate rock grinding methods of the prior art.

The invention thus provides a method for preparing an aqueous suspension of phosphate mineral particles in which the span (S) of the volume distribution of particle sizes [(d_{0.9}−d_{0.1})/d_{0.5}] measured by laser diffraction is less than 4.1, comprising the grinding of at least one phosphate material in the presence of water and of at least one anionic polymer (P) with a molecular mass by weight (Mw) comprised between 1,000 and 90,000 g/mol and obtained by polymerisation reaction of at least one acid chosen among acrylic acid, methacrylic acid and salts thereof.

Preferably according to the invention, the span (S) is less than 4.0 or less than 3.9. More preferentially according to the invention, the span (S) is less than 3.5 or less than 3. Much more preferentially according to the invention, the span (S) is less than 2.5 or less than 2.

Preferably according to the invention, grinding the phosphate rock is followed by a step of separating the smallest particles. Thus, the method according to the invention also comprises at least one step of separating the fraction of phosphate material particles whose size d_{0.1} is less than 4μm or less than 5 μm. Preferably according to the invention, this step makes it possible to separate the fraction of phosphate material particles whose size d_{0.1} is less than 10 μm or less than 20 μm. Also preferably according to the invention, this step makes it possible to separate the fraction of phosphate material particles whose size d_{0.1} is less than 40 μm or less than 50 μm.

Preferably, the separation is carried out by means of a device chosen among liquid-cyclone, centrifuge and combinations thereof.

Preferably according to the invention, the concentration by weight of particles of phosphate material of the aqueous suspension during grinding is greater than 10% or greater than 15%.

Preferably according to the invention, the concentration by weight of particles of phosphate material of the aqueous suspension during grinding is greater than 25%. More preferentially according to the invention, the concentration by weight of particles of phosphate material of the aqueous suspension during grinding is greater than 40% or greater than 50%.

Also preferably according to the invention, the particles of phosphate material have a size d_{0.9} before grinding that is greater than 800 μm or greater than 1,000 μm or greater than 2,500 μm. Also preferably according to the invention, the particles of material have a size d_{0.5} after grinding that is less than 300 μm, preferably less than 250 μm or less than 200 μm.

Very advantageously according to the invention, in addition to controlling the span (S), the method for preparation according to the invention makes it possible to control the grinding time. Generally according to the invention, the grinding time can vary, in particular from 0.5 to 10 hours or vary from 0.5 to 3 hours or from 0.5 to 4 hours or from 0.5 to 5 hours. Preferably according to the invention, the grinding time is less than 5 hours and 30 minutes.

More preferentially according to the invention, the grinding time is less than 4 hours and 30 minutes or less than 3 hours. Much more preferentially according to the invention, the grinding time is less than 2 hours and 30 minutes.

Also preferably according to the invention, the grinding time is less than 5 hours and 30 min or less than 4 hours and 30 min for a concentration by weight of particles of phosphate material of the aqueous suspension during grinding that is greater than 25% or greater than 40%. Also preferably according to the invention, the grinding time is less than 3 hours or less than 2 hours and 30 minutes for a concentration by weight of particles of phosphate material of the aqueous suspension during grinding that is greater than 10% or greater than 15%.

Also very advantageously according to the invention, the grinding time can be very significantly reduced relative to the grinding methods of the prior art. Thus, the method according to the invention makes it possible to reduce the grinding time necessary to obtain an aqueous suspension of phosphate mineral particles in which the span (S) of the volume distribution of particle sizes [(d_{0.9}−d_{0.1})/d_{0.5}] measured by laser diffraction is less than 4.1.

Preferably according to the invention, the grinding time is reduced by at least 10% relative to the grinding time in the absence of polymer (P). More preferentially according to the invention, the grinding time is reduced by at least 20% or by at least 25% relative to the grinding time in the absence of polymer (P).

Much more preferentially according to the invention, the grinding time is reduced by at least 30% or by at least 40% relative to the grinding time in the absence of polymer (P).

The polymer (P) according to the invention is known as such. The polymer (P) used according to the invention is an anionic polymer with a molecular mass by weight (Mw) comprised between 1,000 and 90,000 g/mol and obtained by polymerisation reaction of at least one acid chosen among acrylic acid, methacrylic acid and salts thereof.

Preferably, the polymer (P) is non-sulphonated. Also preferably, the polymer (P) is partially or completely neutralised. More preferentially, it is partially or completely neutralised by means of a derivative comprising at least one element chosen among lithium, sodium, calcium, magnesium and mixtures thereof, much more preferentially chosen among sodium, calcium and combinations thereof

The polymer (P) is known as such. It can be prepared by methods that are also known. Preferably, the polymer (P) is obtained by a polymerisation reaction also using at least one other acid chosen among acrylic acid, methacrylic acid, maleic acid, itaconic acid and salts thereof or at least one ester of an acid chosen among acrylic acid and methacrylic acid.

The preferred polymer (P) according to the invention is chosen among an acrylic acid homopolymer, a copolymer of acrylic acid and of maleic acid.

More preferably, the polymer (P) according to the invention is completely neutralised, particularly by means of sodium or of a combination of sodium and of calcium, for example an equimolar combination of sodium and of calcium.

According to the invention, the anionic polymer (P) has a molecular mass by weight (Mw) comprised between 1,000 and 90,000 g/mol measured by SEC (size exclusion chromatography). Preferably, the polymer (P) has a molecular mass by weight (Mw) comprised between 2,000 and 90,000 g/mol, preferably between 2,000 and 50,000 g/mol, more preferentially between 2,000 and 10,000 g/mol, and even more preferably between 2,000 and 8,000 g/mol.

According to the invention, the molecular weight and the polymolecularity index of the polymers are determined by Size Exclusion Chromatography (SEC), also referred to as “Gel Permeation Chromatography” (GPC). This technique uses a Waters liquid chromatography instrument equipped with a detector. This detector is a Waters refractive index detector. This liquid chromatography instrument is equipped with a size exclusion column in order to separate the various molecular weights of the polymers studied. The liquid elution phase is an aqueous phase adjusted to pH 9.00 using 1N sodium hydroxide containing 0.05 M of NaHCO₃, 0.1 M of NaNO₃, 0.02 M of triethanolamine and 0.03% of NaN₃.

According to a first step, the polymer solution is diluted to 0.9% by dry weight in the dissolution solvent of the SEC, which corresponds to the liquid elution phase of the SEC to which 0.04% of dimethyl formamide, which acts as a flow marker or internal standard, is added. Then, it is filtered using a 0.2 μm filter. Then, 100 μL are injected into the chromatograph (eluent: an aqueous phase adjusted to pH 9.00 by 1N sodium hydroxide containing 0.05 M NaHCO₃, 0.1 M NaNO₃, 0.02 M triethanolamine and 0.03% NaN₃).

The liquid chromatography instrument has an isocratic pump (Waters 515), the flow rate of which is set to 0.8 mL/min. The chromatography instrument also comprises an oven, which itself comprises the following system of columns in series: a Waters Ultrahydrogel Guard precolumn measuring 6 cm in length and 40 mm in inner diameter and a Waters Ultrahydrogel linear column measuring 30 cm in length and 7.8 mm in inner diameter. The detection system is comprised of a Waters 410 RI refractive index detector. The oven is heated to 60° C. and the refractometer is heated to 45° C.

The chromatography instrument is calibrated using powdered sodium polyacrylate standards of different molecular masses certified by the supplier: Polymer Standards Service or American Polymers Standards Corporation (molecular mass ranging from 900 to 2.25×10⁶ g/mol and polymolecularity index ranging from 1.4 to 1.8).

When grinding according to the invention, the amount of polymer (P) may vary. Preferably, the amount by weight (dry/dry) of polymer (P) used is comprised between 0.05 and 5%, preferably between 0.1 and 2%, relative to the amount of phosphate material.

The method according to the invention therefore makes it possible to prepare an aqueous suspension of phosphate mineral particles in which the span (S) of the volume distribution of particle sizes [(d_{0.9}−d_{0.1})/d_{0.5}] measured by laser diffraction is less than 4.1.

The invention therefore also provides an aqueous suspension of mineral particles of phosphate material in which the span (S) of the volume distribution of particle sizes [(d_{0.9}−d_{0.1})/d_{0.5}] measured by laser diffraction is less than 4.1, comprising at least one anionic polymer (P) with a molecular mass by weight (Mw) comprised between 1,000 and 90,000 g/mol and obtained by polymerisation reaction of at least one acid chosen among acrylic acid, methacrylic acid and salts thereof.

The invention therefore also provides a suspension obtained according to the method for preparation according to the invention. The particular, advantageous or preferred characteristics of the method for preparation according to the invention define suspensions according to the invention which are also particular, advantageous or preferred.

The grinding method according to the invention therefore makes it possible to control, improve or reduce the span (S) of the suspension of particles of phosphate material obtained. The invention therefore also provides a method of controlling, preferably of improving or reducing, the span (S) of the volume distribution of particle sizes [(d_{0.9}−d_{0.1})/d_{0.5}], measured by laser diffraction, of a suspension of mineral particles of phosphate material, comprising the grinding of at least one phosphate material in the presence of water and of at least one anionic polymer (P) with a molecular mass by weight (Mw) comprised between 1,000 and 90,000 g/mol and obtained by polymerisation reaction of at least one acid chosen among acrylic acid, methacrylic acid and salts thereof, resulting in an aqueous suspension with a span (S) of less than 4.1.

When used, the method for preparing an aqueous suspension of particles of phosphate material comprising the grinding of this material offers many advantages. In particular, it makes it possible to control or improve the production yield of particles of ground phosphate material. Indeed, the use of the polymer (P) when grinding the phosphate material makes it possible to reduce the span (S) of the aqueous suspension obtained. Since this suspension has a reduced span (S), the number of oversized particles can be limited for use in a subsequent step, for example in a processing step resulting in phosphoric acid. Oversized particles must be ground again.

Similarly, the method for preparing an aqueous suspension according to the invention makes it possible to limit the number of particles whose size is too small to be used in a subsequent step. Generally, these undersized particles must be removed.

Thus, avoiding repeated grinding of oversized particles or avoiding removing undersized particles makes it possible to control or improve the production yield of a phosphate material grinding method.

The invention therefore also provides a method for controlling, preferably for improving, the production yield of a method for grinding a phosphate material in the presence of water, comprising the addition of at least one grinding step, of at least one anionic polymer (P) with a molecular mass by weight (Mw) comprised between 1,000 and 90,000 g/mol and obtained by polymerisation reaction of at least one acid chosen among acrylic acid, methacrylic acid and salts thereof, resulting in an aqueous suspension in which the span (S) of the volume distribution of particle sizes [(d_{0.9}−d_{0.1})/d_{0.5}], measured by laser diffraction, is less than 4.1.

Preferably, the method for controlling or improving the production yield according to the invention makes it possible to improve the yield by at least 10% by weight of ground particles with a span (S) of less than 4.1 relative to particles obtained in the absence of polymer (P). According to the invention, such production yield increases of at least 30% or of at least 50% or of at least 80% or of at least 100%, are possible.

The particular, advantageous or preferred characteristics of the method for preparation according to the invention define methods for controlling the yield or methods for controlling the span (S) according to the invention that are also particular, advantageous or preferred.

The methods for controlling the yield or the methods for controlling the span (S) according to the invention comprise the preparation of a suspension of ground particles with a span (S) according to the invention. The methods for controlling the yield or the methods for controlling the span (S) according to the invention can therefore be defined as methods for preparing a suspension according to the invention.

The following examples illustrate the various aspects of the invention.

An aqueous suspension of phosphate material is prepared by grinding a phosphate rock in the presence of a polymer (P1) or a polymer (P2) defined according to the invention.

Different polymers were prepared and then used in the preparation of phosphate rock slurries by grinding.

Preparation of the polymer (P1):

The following are introduced into a synthesis reactor equipped with a mechanical stirring system and an oil bath heating system:

water: 241.069 g,

copper sulphate pentahydrate: 0.323 g,

ferrous sulphate heptahydrate: 0.276 g.

The medium is heated to 95° C., then the following are added simultaneously and continuously, over 2 hours:

an aqueous solution of 3.5 g of DPTTC sodium salt (CAS # 86470-33-2) at 20.9% by weight, diluted in 31 g of water,

35.3 g of hydrogen peroxide 130 V diluted in 9.4 g of water and

279.9 g of acrylic acid diluted in 31 g of water.

Cooking continues for 1.5 hours at 95° C.

A polyacrylic acid solution with an Mw of 5,700 g/mol and an Ip of 2.5 is obtained (measured by SEC).

The polyacrylic acid solution is treated with:

sodium hydroxide 50% by weight in water: 145 g,

water: 66.660 g,

hydrated lime 97% by weight in water: 42.5 g.

Lastly, the pH of the resulting polymer (P1) is adjusted to 8.7 with sodium hydroxide and to a final concentration of 35% of dry solids content in water.

Preparation of the polymer (P2):

The following are introduced into a synthesis reactor equipped with a mechanical stirring system and an oil bath heating system:

water: 241.069 g,

copper sulphate pentahydrate: 0.323 g,

ferrous sulphate heptahydrate: 0.276 g.

The medium is heated to 95° C., then the following are added simultaneously and continuously, over 2 hours:

an aqueous solution of 3.5 g of DPTTC sodium salt (CAS # 86470-33-2) at 20.9% by weight, diluted in 31 g of water,

35.3 g of hydrogen peroxide 130 V diluted in 9.4 g of water and

279.9 g of acrylic acid diluted in 31 g of water.

Cooking continues for 1.5 hours at 95° C.

A polyacrylic acid solution with an Mw of 5,700 g/mol and an Ip of 2.5 is obtained (measured by SEC).

The polyacrylic acid solution is treated with an aqueous solution of sodium hydroxide at 50% by weight in water to achieve a pH value of 8.5.

Lastly, the pH of the resulting polymer (P2) is adjusted to 8.5 with sodium hydroxide and to a final concentration of 42% of dry solids content in water.

Preparation of the polymer (P3):

The following are introduced into a synthesis reactor equipped with a mechanical stirring system and an oil bath heating system:

water: 190 g,

maleic anhydride: 107.1 g,

ferrous sulphate heptahydrate: 0.0065 g,

sodium hydroxide 50% by weight in water: 169 g.

The medium is heated to 95° C., then the following are added simultaneously and continuously, over 2 hours:

16 g of hydrogen peroxide 130 V,

2.93 g of sodium persulphate diluted in 33 g of water and

131 g of acrylic acid diluted in 37 g of water.

Cooking continues for 1.5 hours at 95° C.

A copolymer solution of acrylic acid and of partially-neutralised maleic acid is obtained.

The polymeric acid solution is treated with an aqueous solution of sodium hydroxide at 50% by weight in water to achieve a pH value of 8.2.

The solution is then brought to a final concentration of 35% of dry solids content in water.

The molecular mass by weight of the polymer thus obtained is about 18,000 g/mol with a polymolecularity index of 3.2.

Preparation of suspensions according to the invention:

Phosphate rock from a mine in China (Guizhou Province) was sieved to separate particles larger than 2.5 mm in size and to separate particles smaller than 40 μm in size.

The sieved rock was then quartered to prepare representative samples with an average mass equal to 320 g±4% that are identical in terms of particle size distribution.

A representative sample is a sample taken in a probabilistic manner such that all of the elements of the batch have an equal probability of being selected for the sample.

The sample collection does not alter the property to be estimated. The conditions are listed in Table 1.

TABLE 1

| | Test A | Test B |
|---|---|---|
| Solids content (% by weight) | 20 | 40 |
| Number of beads and cylinders (g) | 2,823 | 2,823 |
| Amount of water (g) | 1,280 | 960 |
| Amount of dry phosphate rock (g) | 320 | 640 |
| Amount of polymer (P) (% by dry/ | 0.1 | 0.2 |
| dry weight) | | |

The samples are ground separately using a ball mill at a solids content of 20% or 40% by weight in a 4 L jar containing ceramic beads 19 mm in diameter (0.850 L, 1,858 g) and 15×15 mm ceramic cylinders (0.450 L, 965 g) according to the data shown in Table 1.

Aqueous suspensions of phosphate rock are prepared by grinding under test conditions A and in the presence of polymers (P1), (P2) and (P3) respectively, in an amount of 0.1% by dry/dry weight, relative to the amount of rock. The grinding time is set at 2 hours and 20 minutes.

The particle size of the samples is measured with a laser granulometer (Malvern Mastersizer 2000) and processed with Mastersizer 2000 software version 5.61 (refractive index 1.51, pump speed: 1,250 rpm, mixer speed: 750 rpm, ultrasound stirring at 50% of the power throughout the measurement). Seven measurements, spaced 10 s apart, are taken per aliquot. Three wash cycles are run between each series of three measurements.

For each suspension, seven repeat measurements are taken, the particle size is measured, and the results of the average particle size measurements are shown in Table 2.

TABLE 2

| | Particle size (μm) | | | |
|---|---|---|---|---|
| Polymer | d_{0.1} | d_{0.5} | d_{0.9} | Span (S) |
| P1 | 4.085 | 198.371 | 388.446 | 1.938 |
| P2 | 6.073 | 233.306 | 876.110 | 3.732 |
| P3 | 4.934 | 278.785 | 1,026.326 | 3.664 |

The use of polymers (P1), (P2) and (P3) enables excellent control of the particle size of the prepared suspensions as well as achieving a span (S) of much less than 4.1.

Other aqueous suspensions of phosphate rock are prepared by grinding under test conditions A in the absence of polymer and in the presence of polymer (P1) in an amount of 0.1% by dry/dry weight relative to the amount of rock. The target particle size day is less than 200 μm (198 μm±1.5%).

For each suspension, seven repeat measurements are taken, the particle size is measured, and the results of the average particle size measurements are shown in Table 3.

The time required to achieve the target particle size is assessed. The results are shown in Table 3.

TABLE 3

| | Grinding | Particle size (μm) | | | |
|---|---|---|---|---|---|
| Polymer | time | d_{0.1} | d_{0.5} | d_{0.9} | Span (S) |
| None | 4 hrs | 4.368 | 200.588 | 836.604 | 4.149 |
| P1 | 2 hrs 20 min | 4.085 | 198.371 | 388.446 | 1.938 |

The use of polymer (P1) makes it possible to achieve a much smaller span (S) relative to the preparation of a suspension in the absence of polymer. Moreover, the time required to achieve this result is reduced by more than 40%. Other aqueous suspensions of phosphate rock are prepared by grinding under test conditions B in the absence of polymer and in the presence of polymer (P1) in an amount of 0.2% by dry/dry weight relative to the amount of rock. The target particle size d_{0.5} is less than 200 μm (198 μm ±1.5%).

For each suspension, seven repeat measurements are taken, the particle size is measured, and the results of the average particle size measurements are shown in Table 4.

The time required to achieve the target particle size is assessed. The results are shown in Table 4.

TABLE 4

| | Grinding | Particle size (μm) | | | |
|---|---|---|---|---|---|
| Polymer | time | d_{0.1} | d_{0.5} | d_{0.9} | Span (S) |
| None | 6 hrs | 3.419 | 199.069 | 895.315 | 4.480 |
| P1 | 4 hrs | 3.759 | 195.711 | 762.673 | 3.877 |

For highly concentrated suspensions, the use of polymer (P1) makes it possible to achieve a much smaller span (S) relative to the preparation of a suspension in the absence of polymer. Moreover, the time required to achieve this result is reduced by more than 30%.

Table 5 presents the comparison of these different results.

TABLE 5

| | Grinding | % Solids | Particle size (μm) | | | |
|---|---|---|---|---|---|---|
| Polymer | time | content | d_{0.1} | d_{0.5} | d_{0.9} | Span (S) |
| None | 4 hrs | 20 | 4.368 | 200.588 | 836.604 | 4.149 |
| P1 (0.1%) | 2 hrs 20 min | 20 | 4.085 | 198.371 | 388.446 | 1.938 |
| None | 6 hrs | 40 | 3.419 | 199.069 | 895.315 | 4.480 |
| P1 (0.2%) | 4 hrs | 40 | 3.759 | 195.711 | 762.673 | 3.877 |

The method according to the invention makes it possible to prepare an aqueous suspension of phosphate material according to the invention that is particularly effective in achieving the target particle size distribution values and controlling the span (S) for different solids contents during grinding. The span (S) and the grinding times are particularly reduced through the use of polymers (P).

1. A method for preparing an aqueous suspension of phosphate mineral particles, comprising:
grinding a of at least one phosphate material in the presence of water and an anionic polymer (P) with a molecular mass by weight (M_{W}) between 1,000 and 90,000 g/mol, wherein the anionic polymer (P) is obtained by polymerisation reaction of at least one acid selected from the group consisting of acrylic acid, methacrylic acid and salts thereof,
wherein a span (S) of a volume distribution of particle sizes [(d_{0.9}−d_{0.1})/d_{0.5}] measured by laser diffraction is less than 4.1.

2. The method according to claim 1, wherein the span (S) is less than 4.0.

3. The method according to claim 1 further comprising separating a fraction of particles of the phosphate material whose size d_{0.1} is less than 4 μm.

4. The method according to claim 3, wherein the separation is carried out in a liquid-cyclone, centrifuge or a combination thereof.

5. The method according to claim 3, wherein a concentration by weight of the phosphate mineral particles of the aqueous suspension during the grinding is greater than 10%.

6. The method according to claim 5, wherein the particles of the phosphate material have a size d_{0.9} before the grinding that is greater than 800 μm.

7. The method according to claim 6, wherein the particles of the phosphate material have a size d_{0.5} after the grinding that is less than 300 μm.

8. The method according to claim 1, wherein a grinding time is less than 5 hrs and 30 min.

9. The method according to claim 1, wherein a grinding time is reduced by at least 10% relative to a grinding time in an absence of the anionic polymer (P).

10. The method according to claim 1, wherein the anionic polymer (P) is partially or completely neutralised.

11. The method according to claim 1, wherein the anionic polymer (P) is obtained by a polymerisation reaction with at least one acid selected from the group consisting of acrylic acid, methacrylic acid, maleic acid, itaconic acid and salts thereof or at least one ester of an acid chosen among acrylic acid and methacrylic acid.

12. The method according to claim 1, wherein the anionic polymer (P) has a molecular mass by weight (M_{W}) between 2,000 and 90,000 g/mol.

13. The method according to claim 1, wherein an amount by weight (dry/dry) of the anionic polymer (P) is between 0.07 and 2% relative to an amount of the phosphate material.

14. An aqueous suspension of mineral particles of a phosphate material, comprising:
at least one anionic polymer (P) with a molecular mass by weight (M_{W}) between 1,000 and 90,000 g/mol, wherein the anionic polymer (P) is obtained by polymerisation reaction of at least one acid selected from the group consisting of acrylic acid, methacrylic acid and salts thereof,
wherein a span (S) of a volume distribution of particle sizes [(d_{0.9}−d_{0.1})/d_{0.5}] measured by laser diffraction is less than 4.1.

15. A suspension obtained by the method of claim 1.

16.-19. (canceled)

20. The method according to claim 11, wherein the anionic polymer (P) is partially or completely neutralised by at least one derivative selected from the group consisting of lithium, sodium, calcium, magnesium and mixtures thereof.
